(19) United States
(12) Patent Application Publication
(10) Pub. No.: US 2015/0295510 A1
(43) Pub. Date: Oct. 15, 2015

(54) UNIVERSAL POWER SUPPLY APPARATUS

(71) Applicant: SAMSUNG ELECTRO-MECHANICS CO., LTD., Suwon-Si (KR)

(72) Inventors: Young Seung Noh, Suwon-Si (KR); Kwang Soo Choi, Suwon-Si (KR); Bo Mi Lee, Suwon-Si (KR); Chan Sung Jang, Suwon-Si (KR)

(73) Assignee: SAMSUNG ELECTRO-MECHANICS CO., LTD., Suwon-Si (KR)

(21) Appl. No.: 14/497,301

(22) Filed: Sep. 25, 2014

(30) Foreign Application Priority Data
Apr. 9, 2014 (KR) 10-2014-0042489

(51) Int. Cl. H02M 7/217

(52) U.S. Cl. CPC H02M 7/217

(57) ABSTRACT

A universal power supply apparatus may include a power converting unit converting input power into a plurality of voltages having preset levels, a path providing unit providing transfer paths for the plurality of voltages having preset levels from the power converting unit and having a common capacitor connected to an output terminal of the transfer paths, a voltage selecting circuit unit selecting at least one output of the transfer paths corresponding to each of the plurality of voltages having preset levels, and a voltage controlling unit controlling a voltage of output power according to the selection of the voltage selecting circuit unit.

### CROSS-REFERENCE TO RELATED APPLICATION

This application claims the benefit of Korean Patent Application No. 10-2014-0042489 filed on Apr. 9, 2014, with the Korean Intellectual Property Office, the disclosure of which is incorporated in its entirety herein by reference.

### BACKGROUND

The present disclosure generally relates to a universal power supply apparatus capable of supplying power to a variety of devices.

Recently, processes of systemization and digitization, as well as the implementation of wireless communications, multimedia capabilities, intelligent functions, component complexity, and the like, have been conducted in portable electronic devices in general. In this regard, as social interest in multimedia has increased, small, portable multimedia devices have come to prominence.

Here, as mobile devices such as a smartphones and tablet personal computers (PCs) have become prominent as new information delivery devices, new technology requirements for driving power supply apparatuses, such as adapters for charging the batteries of such apparatuses have increased.

In driving power supply apparatuses, controls governing standby power may be used. However, as device elements, such as touchscreens, allowing for increased levels of functionality, have been added to mobile devices, a situation in which the effect of a driving power supply apparatus on a body during a time in which the driving power supply apparatus is used to charge such a mobile device needs to be decreased has occurred.

Meanwhile, as various mobile devices have been developed, research into new types of driving power supply apparatuses has been demanded in which a single driving power supply apparatus may apply power having required voltage levels to several different types of mobile device.

Since the power rating specifications of mobile devices are as varied as mobile devices themselves, dedicated driving power supply apparatuses are required for respective individual devices. Here, manufacturing costs may be increased, as well as the need to design and manufacture unique driving power supply apparatuses for use in various mobile devices.

For instance, in the case that an input voltage of the mobile device is 5 V, for example, a device such as a laptop computer, requiring a large amount of input power consumes a large amount of current, thereby necessitating a separate heat dissipation unit for absorbing heat generated by the device.

That is, a size of such a driving power supply apparatus may necessarily be relatively large, thereby increasing manufacturing costs.

On the other hand, in the case in which an output voltage is increased to 12V, for example, a device (a smartphone or the like) having a low input voltage may consume a decreased amount of current. However, an element having a low withstand voltage and a low price may be used in order to manufacture a device which is miniaturized and available at a low price, and an element having a high withstand voltage, increased by an amount equal to an increased range of the input voltage may be then used. In general, since elements having a high withstand voltages are commonly fairly large and require high manufacturing costs, it may be difficult to use a driving power supply apparatus providing a single voltage level in a variety of devices.

In order to solve this problem, integrated power supply apparatuses may be used. However, such integrated power supply apparatuses according to the related art may have respective power circuits to provide voltages having various levels, such that a volume may be increased and manufacturing costs may be increased.

Therefore, the development of a novel driving power supply apparatus capable of being used in several different devices has been demanded.

### RELATED ART DOCUMENT

(Patent Document 1) Korean Patent Laid-Open Publication No. 10-2011-0062549

### SUMMARY

An exemplary embodiment in the present disclosure may provide a universal power supply apparatus capable of varying a voltage level of an output power.

According to an exemplary embodiment in the present disclosure, a universal power supply apparatus may include: a power converting unit converting input power into a plurality of voltages having preset levels; a path providing unit providing transfer paths for the plurality of voltages having preset levels from the power converting unit and having a common capacitor connected to an output terminal of the transfer paths for the plurality of voltages having preset levels; a voltage selecting circuit unit selecting at least one outputs of the transfer paths corresponding to each of the plurality of voltages having preset levels; and a voltage controlling unit controlling a voltage of output power by selecting the output of the transfer path for each of the plurality of voltages having preset levels according to the selection of the voltage selecting circuit unit.

The power converting unit may include: a switching control unit controlling switching of the input power; and a switching unit outputting the plurality of voltages having preset levels by switching the input power according to a switching control of the switching control unit.

The switching unit may include: a switch switching the input power according to the switching control of the switching control unit; and a transformer having a primary winding receiving the power switched by the switching of the switch, secondary windings magnetically coupled to the primary winding and having at least one center tap to thereby output the plurality of voltages having the preset levels, and an auxiliary winding supplying driving power to the switching control unit.

The secondary windings may have one basic secondary winding and at least one divided winding, divided by the center tap.

The basic secondary winding may be magnetically coupled to the primary winding to thereby form a preset winding ratio and transform and output a voltage level of the switched power according to the winding ratio, and the divided winding may be magnetically coupled to the primary winding and have a power transfer path controlled according to a control to thereby form a winding ratio together with the basic secondary winding and transform and output the voltage level of the switched power.

The path providing unit may include: a basic path providing unit connected to an output terminal of the basic secondary winding to thereby output basic power; and at least one additional path providing unit connected to the at least one divided winding and controlled by the voltage controlling unit to thereby output additional power from the at least one divided winding.

The additional path providing unit may include: a switch being controlled according to the control; and a diode stabilizing power transferred from a corresponding divided winding through a path controlled by the switch.

The additional path providing unit may include: a diode stabilizing power transferred from a corresponding divided winding; and a switch being controlled according to the control to thereby output power from the diode.

The voltage controlling unit may include: a photo coupler transferring a switching control signal to the switching control unit according to a reference voltage level; and a shunt regulator varying the reference voltage level according to a voltage selection of the voltage selecting circuit unit.

The voltage selecting circuit unit may include at least one voltage selecting unit changing a resistance level together with a conduction switching of the additional path providing unit to vary the reference voltage level of the shunt regulator.

According to another exemplary embodiment in the present disclosure, a universal power supply apparatus may include: a power converting unit switching input power and including a transformer having a primary winding receiving the switched power and secondary windings magnetically coupled to the primary winding and including at least one center tap to thereby output the plurality of voltages having preset levels; a path providing unit providing transfer paths for the plurality of voltages having the preset levels from the secondary windings and having a common capacitor connected to an output terminal of the transfer paths for each of the plurality of voltages having the preset levels; a voltage selecting circuit unit selecting at least one output of the transfer paths corresponding to each of the plurality of voltages having the preset levels; and a voltage controlling unit controlling a voltage of output power by selecting the output of the transfer path for each of the plurality of voltages having the preset levels according to the selection of the voltage selecting circuit unit.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic block diagram of a universal power supply apparatus according to an exemplary embodiment in the present disclosure; and

FIGS. 2 and 3 are circuit diagrams schematically showing the universal power supply apparatus according to an exemplary embodiment in the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

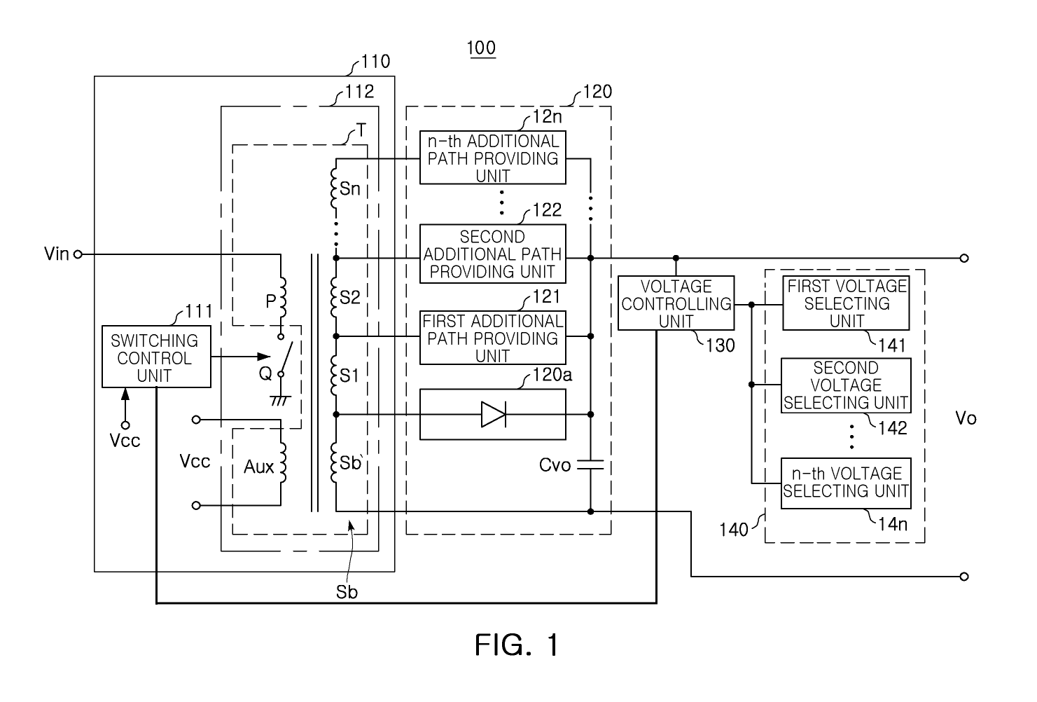

FIG. 1 is a schematic block diagram of a universal power supply apparatus according to an exemplary embodiment in the present disclosure.

Referring to FIG. 1, a universal power supply apparatus 100 according to an exemplary embodiment of the present disclosure may include a power converting unit 110, a path providing unit 120, a voltage controlling unit 130, and a voltage selecting circuit unit 140.

The power converting unit 110 may include a switching control unit 111 and a switching unit 112.

The switching control unit 111 may be driven by receiving driving power Vcc from the switching unit 112 and be configured to control a power switching of the switching unit 112 in response to a switching control signal from the voltage controlling unit 130.

The switching unit 112 may include a switch Q and a transformer T.

The switch Q may switch input power Vin according to a control of the switching control unit 111. The transformer T may include a primary winding P, secondary windings Sb (S1 to Sn), and an auxiliary winding Aux.

One end of the primary winding P is transferred with input power Vin and the other end thereof is connected to the switch Q, such that the primary winding P may transfer power switched according to the switching of the switch Q to the secondary windings Sb (S1 to Sn). The secondary windings Sb (S1 to Sn) may transform and output the switched power from the primary winding P according to a winding ratio formed by a magnetic coupling between the primary winding P and the secondary windings Sb (S1 to Sn).

The path providing unit 120 may provide transfer paths for the power output from the respective secondary windings Sb (S1 to Sn).

The secondary windings Sb (S1 to Sn) are divided by a center tap to thereby have a basic secondary winding Sb and one or more divided secondary windings S1 to Sn. A basic path providing unit 120a of the path providing unit 120 may provide an output transfer path of the power from the basic secondary winding Sb′. One or more additional path providing units 121 to 12n may be connected to one or more divided secondary windings S1 to Sn to thereby provide the output transfer paths of the power from one or more divided secondary windings S1 to Sn.

First to n-th additional path providing units 121 to 12n maybe each connected to a corresponding divided secondary winding among first to n-th divided secondary windings S1 to Sn to thereby provide an output transfer path of power of the corresponding divided secondary winding, and may be switched on or off according to the control signal to thereby output the power of the corresponding divided secondary winding.

The power of the corresponding divided secondary winding maybe transferred from the basic secondary winding Sb output through the transfer path provided by the basic path providing unit 120a, which in turn may be coupled to a common capacitor Cvo and output.

The voltage controlling unit 130 may vary a voltage level of the output power by adjusting or generating the switching control signal fed back to the switching control unit 111.

The voltage selecting circuit unit 140 may include first to n-th voltage selecting units 141 to 14n. A control signal operating the first to n-th voltage selecting units 141 to 14n may have the same switching on or off as the control signal selecting the additional path providing unit of the first to n-th additional path providing units 121 to 12n.

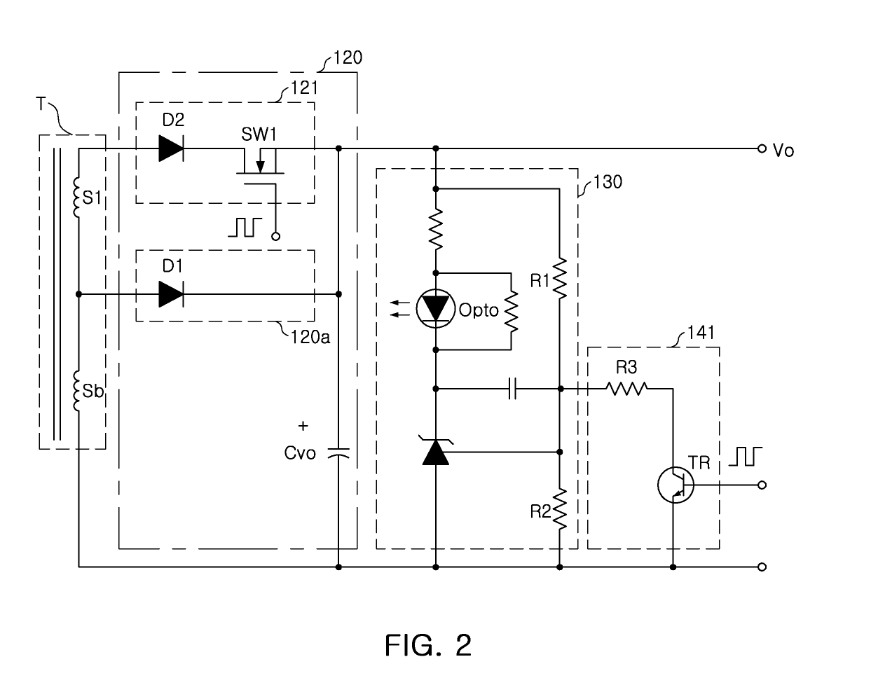

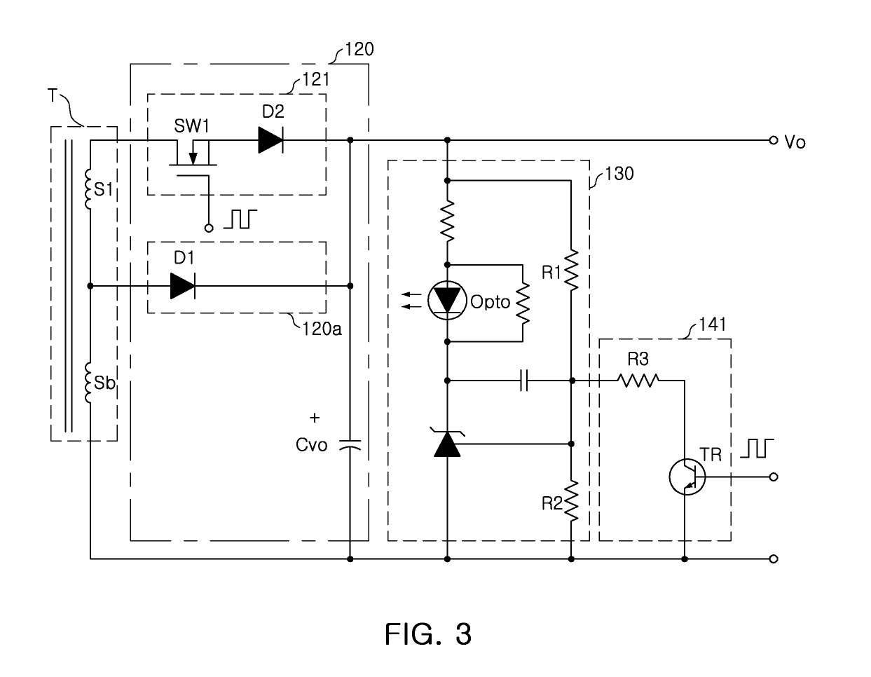

FIGS. 2 and 3 are circuit diagrams schematically showing the universal power supply apparatus according to an exemplary embodiment in the present disclosure.

Referring to FIG. 2 or 3 together with FIG. 1, the universal power supply apparatus 100 according to an exemplary embodiment of the present disclosure may be described using the basic path providing unit 120a and one additional path providing unit 121 by way of example. Therefore, the secondary windings Sb may have the basic secondary winding Sb′ and one divided winding S1, and the voltage selecting circuit unit 140 may have the first voltage selecting unit 141, but are not limited thereto.

First, referring to FIGS. 1 and 2, the basic path providing unit 120a may be configured by one diode D1, and the additional path providing unit 121 may be configured by the diode D2 and a switch SW1. The switch SW1 may be switched on or off in response to the control signal to thereby provide a transfer path of power from the divided winding S1.

For example, in a state in which power from the basic secondary winding Sb′ is output, if the addition path providing unit 121 forms the power transfer path, power from the secondary winding Sb formed by coupling the divided winding S1 and the basic secondary winding Sb′ is charged in the common capacitor Cvo, such that charged power may be output. In this case, the diode D1 of the basic path providing unit 120a connected to a connection point between the basic secondary winding Sb′ and the divided winding S1 is turned off and a diode D2 of the additional path providing unit 121 is turned on, such that the power from the secondary winding Sb formed by coupling the divided winding S1 and the basic secondary winding Sb′ may be output. Accordingly, the voltage level of the output power may be varied. For example, the voltage level of the power from the basic secondary winding Sb′ may be set to 5V, and the voltage level of the power of the secondary winding Sb formed by coupling the divided winding S1 and the basic secondary winding Sb′ may be is set to 12V, such that the voltage level of the output power may be varied, if necessary to thereby supply the power to various devices.

In addition, since the output power of the secondary winding Sb is coupled to the common capacitor Cvo, a circuit area and manufacturing costs may be reduced. Since the secondary windings Sb which are divided and wound by the center tap of the secondary winding Sb are used, a winding ratio of the auxiliary winding Aux may be not significantly changed, and in the voltage level of the driving power Vcc supplied to the switching control unit 111 may be not significantly changed, whereby a switching control integrated chip (IC) having various voltage levels of the driving power may be used.

Meanwhile, the voltage controlling unit 130 may have a photo coupler Opto feeding back a state of the output power to the switching control unit 111 of a primary side as a switching control signal, and a shunt regulator may be connected between the photo coupler Opto and a ground. A reference voltage of the shunt regulator may be varied according to a resistance ratio of connected resistors, and a switch TR of the first voltage selecting unit 141 may be switched on or off by equally receiving the control signal controlling the switch SW1 of the additional path providing unit 121, such that a resistance ratio of resistors R1, R2, and R3 of the shunt regulator may be varied.

That is, in the case in which the power is transferred to the basic path providing unit 120a and the power transfer path of the first additional path providing unit 121 is blocked, the switch TR of the first voltage selecting unit 141 is also switched off, such that the resistance ratio of the shunt regulator may be formed by the first resistor R1 and the second resistor R2.

On the other hand, in the case in which the switch SW1 of the first additional path providing unit 121 is switched on, the switch TR of the first voltage selecting unit 141 is also switched on, such that the resistance ratio of the shunt regulator may be formed by the summation of the first resistor R1, the second resistor R2 and the third resistor R3.

Referring to FIG. 3, since another exemplary embodiment of the present disclosure has configurations and operations of components similar with or the same as those shown in FIG. 2, except that the order of the switch SW1 and the diode D1 of the first additional path providing unit 121 is changed, a detailed description thereof will be omitted.

As set forth above, according to exemplary embodiments of the present disclosure, various powers may be output by selectively coupling the plurality of voltages having preset levels from the secondary windings Sb divided by the center tap, the circuit area and the manufacturing costs may be reduced by using the common capacitor Cvo in the output terminal, and since the plurality of voltages having preset levels from the divided secondary windings Sb are selectively coupled, the variation in the voltage level of the auxiliary power may be decreased, such that various switching control ICs may be used.

While exemplary embodiments have been shown and described above, it will be apparent to those skilled in the art that modifications and variations could be made without departing from the spirit and scope of the present disclosure as defined by the appended claims.

What is claimed is:

1. A universal power supply apparatus, comprising:
a power converting unit converting input power into a plurality of voltages;
a path providing unit providing transfer paths for the plurality of voltages from the power converting unit and having a common capacitor connected to an output terminal of the transfer paths; and
a voltage controlling unit controlling a voltage of output power by selecting at least one of the transfer paths corresponding to each of the plurality of voltages.

2. The universal power supply apparatus of claim 1, wherein the power converting unit includes:
a switching control unit controlling switching of the input power; and
a switching unit outputting the plurality of voltages having preset levels by switching the input power according to a switching control of the switching control unit.

3. The universal power supply apparatus of claim 2, wherein the switching unit includes:
a first switch switching the input power according to the switching control of the switching control unit; and
a transformer having a primary winding receiving the power switched by the switching of the switch, secondary windings magnetically coupled to the primary winding and having at least one center tap to output the plurality of voltages having the preset levels, and an auxiliary winding supplying driving power to the switching control unit.

4. The universal power supply apparatus of claim 3, wherein the secondary windings comprise a basic secondary winding and at least one divided winding, divided by the center tap.

5. The universal power supply apparatus of claim 4, wherein the basic secondary winding is magnetically coupled to the primary winding to form a preset winding ratio and transforms and outputs a voltage level of the switched power according to the winding ratio, and
the divided winding is magnetically coupled to the primary winding and has a power transfer path controlled according to a control to form a winding ratio with the basic secondary winding and transforms and outputs the voltage level of the switched power.

6. The universal power supply apparatus of claim 5, wherein the path providing unit includes:
a basic path providing unit connected to an output terminal of the basic secondary winding to output basic power; and
at least one additional path providing unit connected to the at least one divided winding and controlled by the voltage controlling unit to output additional power from the at least one divided winding.

7. The universal power supply apparatus of claim 6, wherein the additional path providing unit includes:
a second switch being controlled according to the control; and
a diode stabilizing power transferred from a corresponding divided winding through a path controlled by the second switch.

8. The universal power supply apparatus of claim 6, wherein the additional path providing unit includes:
a diode stabilizing power transferred from a corresponding divided winding; and
a third switch being controlled according to the control to output power from the diode.

9. The universal power supply apparatus of claim 6, wherein the voltage controlling unit includes:
a photo coupler transferring a switching control signal to the switching control unit according to a reference voltage level; and
a shunt regulator varying the reference voltage level according to a voltage selection by a voltage selecting circuit unit.

10. The universal power supply apparatus of claim 9, wherein the voltage selecting circuit unit includes at least one voltage selecting unit changing a resistance level with a conduction switching of the additional path providing unit to vary the reference voltage level of the shunt regulator.

11. A universal power supply apparatus, comprising:
a power converting unit switching input power and including a transformer comprising:
a primary winding receiving the switched power; and
secondary windings magnetically coupled to the primary winding and including at least one center tap to output a plurality of voltages having preset levels;
a path providing unit providing transfer paths for the plurality of voltages having the preset levels from the secondary windings and having a common capacitor connected to an output terminal of the transfer paths;
a voltage selecting circuit unit selecting at least one output of the transfer paths corresponding to each of the plurality of voltages; and
a voltage controlling unit controlling a voltage of output power according to the selection of the voltage selecting circuit unit.

12. The universal power supply apparatus of claim 11, wherein the secondary winding has a basic secondary winding and at least one divided winding, divided by the center tap.

13. The universal power supply apparatus of claim 12, wherein the basic secondary winding is magnetically coupled to the primary winding to form a preset winding ratio and transforms and outputs a voltage level of the switched power according to the winding ratio, and
the divided winding is magnetically coupled to the primary winding and has a power transfer path controlled according to a control to form a winding ratio with the basic secondary winding and transforms and outputs the voltage level of the switched power.

14. The universal power supply apparatus of claim 13, wherein the path providing unit includes:
a basic path providing unit connected to an output terminal of the basic secondary winding to output basic power; and
at least one additional path providing unit connected to the at least one divided winding and controlled by the voltage controlling unit to output additional power from the at least one divided winding.

15. The universal power supply apparatus of claim 14, wherein the additional path providing unit includes:
a first switch being controlled according to the control; and
a diode stabilizing power transferred from a corresponding divided winding through a path controlled by the first switch.

16. The universal power supply apparatus of claim 14, wherein the additional path providing unit includes:
a diode stabilizing power transferred from a corresponding divided winding; and
a second switch being controlled according to the control to output power from the diode.

17. The universal power supply apparatus of claim 14, wherein the voltage controlling unit includes:
a photo coupler transferring a switching control signal to the switching control unit according to a reference voltage level; and
a shunt regulator varying the reference voltage level according to a voltage selection of the voltage selecting circuit unit.

18. The universal power supply apparatus of claim 17, wherein the voltage selecting circuit unit includes at least one voltage selecting unit changing a resistance level with a conduction switching of the additional path providing unit to vary the reference voltage level of the shunt regulator.

19. The universal power supply apparatus of claim 17, wherein the power converting unit further includes:
a switching control unit controlling switching of the input power according to the switching control signal; and
a switching unit outputting the plurality of voltages having the preset levels by switching the input power according to a switching control of the switching control unit,
wherein the switching unit includes:
a switch switching the input power according to the switching control of the switching control unit; and
the transformer further comprising an auxiliary winding supplying driving power to the switching control unit.
